(19) United States
(12) Patent Application Publication
(10) Pub. No.: US 2016/0110165 A1
(43) Pub. Date: Apr. 21, 2016

(54) QUALITY DETECTING METHOD, RANDOM NUMBER GENERATOR, AND ELECTRONIC DEVICE

(71) Applicant: FUJITSU LIMITED, Kawasaki-shi (JP)

(72) Inventors: Hirotaka KOKUBO, Minato (JP); Dai YAMAMOTO, Kawasaki (JP); Masahiko TAKENAKA, Kawasaki (JP); Kazuyoshi Furukawa, Kawasaki (JP)

(21) Appl. No.: 14/847,078

(22) Filed: Sep. 8, 2015

(30) Foreign Application Priority Data
Oct. 15, 2014 (JP) 2014-210969

(51) Int. Cl. G06F 7/58

(52) U.S. Cl. CPC G06F 7/588

(57) ABSTRACT

A quality detecting method, includes: storing, in a memory, an upper limit value and a lower limit value that specify a distribution range of a score corresponding to at least one type for each of variant random number sequences generated by shuffling an initial random number sequence; and causing a computer to: generate verification random number sequences; calculate a score corresponding to the type for each of the verification random number sequences; compare the scores of the verification random number sequences with the upper limit value and the lower limit value; acquire a frequency at which the scores of the verification random number sequences are distributed in the distribution range based on a comparison result; and detect, based on the frequency, quality of a physical random number generation circuit.

### CROSS-REFERENCE TO RELATED APPLICATION

This application is based upon and claims the benefit of priority of the prior Japanese Patent Application No. 2014-210969, filed on Oct. 15, 2014, the entire contents of which are incorporated herein by reference.

### FIELD

The embodiments discussed herein are related to a quality detecting method, a random number generator, and an electronic device.

### BACKGROUND

In order to manage services which utilize an information network, for example, services of electronic payment, a cloud storage and so on, safety is secured by information security technologies including various encryption systems.

A related technology is disclosed in Japanese Laid-open Patent Publication No. 2008-197847, Japanese Laid-open Patent Publication No. 2006-318092, Japanese Laid-open Patent Publication No. 2004-310314, or a non-patent literature, NIST DRAFT Special Publication 800-904 “Recommendation for the Entropy Sources Used for Random Bit Generation”, Elaine Barker, John Kelsey.

### SUMMARY

According to an aspect of the embodiments, a quality detecting method, includes: storing, in a memory, an upper limit value and a lower limit value that specify a distribution range of a score corresponding to at least one type for each of variant random number sequences generated by shuffling an initial random number sequence; and causing a computer to: generate verification random number sequences; calculate a score corresponding to the type for each of the verification random number sequences; compare the scores of the verification random number sequences with the upper limit value and the lower limit value; acquire a frequency at which the scores of the verification random number sequences are distributed in the distribution range based on a comparison result; and detect, based on the frequency, quality of a physical random number generation circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a physical random number generator;

FIG. 2 illustrates an example of an analysis machine;

FIG. 3 illustrates an example of processing of a shuffling test;

FIG. 4 illustrates an example of a physical random number generator;

FIG. 5 illustrates an example of a memory cost (capacity);

FIG. 6 illustrates an example of a physical random number generator;

FIG. 7 illustrates an example of a shuffling test unit;

FIG. 8 illustrates an example of a score list storage unit;

FIG. 9 illustrates an example of physical random number generation processing;

FIG. 10 illustrates an example of a physical random number generation processing; and

FIG. 11 illustrates an example of an electronic device.

### DESCRIPTION OF EMBODIMENTS

In encryption systems, data (called a plain text) is converted to data (called an encrypted text) difficult for a third party to understand. The encryption systems include a public key encryption system and a common key encryption system. In the public key encryption system, respective keys different from each other are used in encryption and decoding. A key (called a public key) for performing encryption is made available to the public and a key (called a secret key) for decoding an encrypted text is defined as confidential information used only for a recipient, thereby causing an encrypted text to be created, the encrypted text being comprehensible only to the recipient.

In an encryption system called the common key encryption system, the same key (called a secret key) is used in encryption and decoding. The secret key is kept secret from a third party other than a sender and a recipient, thereby maintaining the safety of data. It is only possible for a person, who knows the secret key, to decipher an encrypted text of the common key encryption system.

The safety of the encryption system depends on the safety of the secret key. If the secret key is predicted by a third party by using some kind of method, the encrypted text is deciphered by the third party. Therefore, data is not protected. Accordingly, the secret key may be generated using a random number difficult for the third party to predict.

The random number is roughly classified into a pseudo random number and a physical random number (true random number), based on generation methods therefor. The pseudo random number indicates a portion of a sequence of numbers created by deterministic calculation. By assigning an initial value (called a seed) to a pseudo random number generation algorithm, the pseudo random number is generated. If the pseudo random number generation algorithm and the seed are understood, the pseudo random number may be predicted. Therefore, generation of the secret key by using the pseudo random number and the predictable seed may have a safety issue. However, since the pseudo random number is generated by calculation, the pseudo random number is generated in a CPU without using a special device. The physical random number is extracted from a random physical phenomenon such as a thermal noise within a device. Since a good physical random number has no reproducibility and is difficult to predict, the physical random number has high safety as a seed generation method for a pseudo random number generator. Since the pseudo random number generator that uses, as the seed, the good physical random number generates an unpredictable pseudo random number, such a generator is suitable for generating the secret key.

In a case where, for example, the quality of the physical random number is poor and a random number property is low, the safety of the secret key is reduced. Since the physical random number generator is influenced by an environmental change such as a change in temperature or voltage or passage of years, the random number property of the generated physical random number may be reduced. Therefore, it is dangerous to generate the secret key, based on the physical random number whose random number property is low. While the physical random number generator is used for encrypted communication or digital signature authentication of a device desired to secure safety, such as a smart card or a mobile phone, the small-sized and portable device is easily influenced by an environment. Therefore, in order to reduce a risk that a fragile secret key is generated due to deterioration of the random number property of the physical random number, the random number property (entropy) of the physical random number is dynamically measured.

As the specification of the entropy of the physical random number generator, a specification described in, for example, the document [SP800-90B] of the United States, related to a physical random number generator, may be adopted. A health test includes, for example, a Repetition Count Test and an Adaptive Proportion Test, and a self-test circuit that performs the health test is mounted. In a case where the random number property of a generated random number is determined to be low by the health test, the random number sequence is not output. Therefore, the health test may be performed every time the physical random number generator is actually used. For example, the health test detects a state in which the physical random number generation circuit continues to continuously output the same value.

An IID test is a test, which checks the random number property and which is performed at the time of manufacturing the physical random number generator, and includes a shuffling test and a statistical test. In a case of passing the two tests, passing the IID test is determined. In the IID test, a random number sequence whose random number property is low and which is not detected in the health test is detected. The shuffling test included in the IID test has a large processing cost. Therefore, the IID test is not implemented at time of using the physical random number generator but is implemented on an analysis machine only at time of manufacturing the physical random number generator, and a defective physical random number generator whose random number property is low is excluded.

In the physical random number generator, owing to an environmental change or passage of years, the random number property of an output random number may be reduced. In a case of performing, in such a manner as in the IID test, a test only at the time of production, no reduction of the random number property at the time of actual use may be detected after shipment. Since the processing cost is large, it may be difficult to mount, in the physical random number generator, a test circuit that performs the IID test in an on-chip manner.

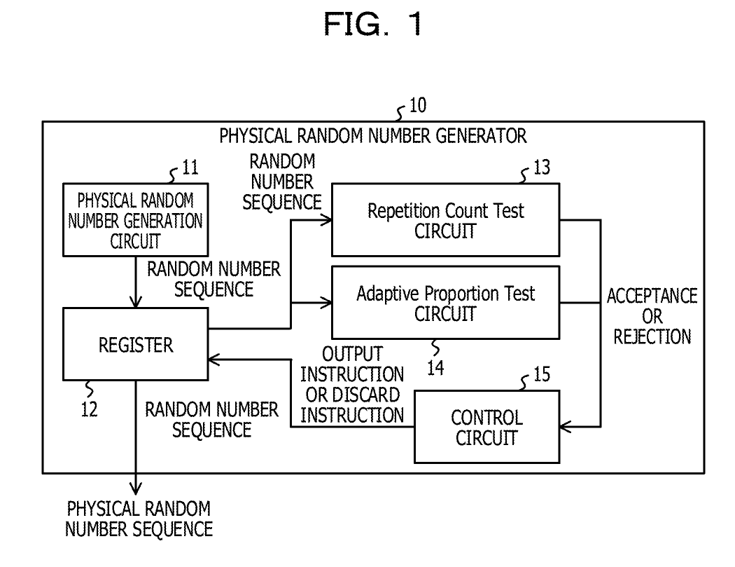

FIG. 1 illustrates an example of a physical random number generator. The physical random number generator illustrated in FIG. 1 may be compliant with the document [SP800-90B] of the United States, related to the physical random number generator.

A physical random number generator 10 in FIG. 1 includes a physical random number generation circuit 11, a register 12, a Repetition Count Test (repetition count test) circuit 13, an Adaptive Proportion Test (adaptive proportion test) circuit 14, and a control circuit 15. The physical random number generation circuit 11 generates a physical random number by using an arbitrary method such as a thermal noise or an RS latch. The register 12 temporarily stores therein the random number generated by the physical random number generation circuit 11. The Repetition Count Test circuit 13 and the Adaptive Proportion Test circuit 14 form a health test circuit that tests the random number property of a received random number sequence in a simple manner. The health test circuit performs self-test, which is called a health test and which is compliant with [SP800-90B], on the random number sequence stored in the register 12 and tests, in a simple manner, the random number property of the received random number sequence. In a case of passing the two tests, the control circuit 15 determines that the random number property is high, and the control circuit 15 instructs the register 12 to output the random number sequence. In a case of failing one of the two tests, the control circuit 15 determines that the random number property is low, and the control circuit 15 instructs the register 12 to discard the random number sequence without outputting the random number sequence. In a case of passing the two health tests, the random number is output.

The health test is performed every time the physical random number generator 10 is actually used. The health test detects a state in which the physical random number generation circuit continues to significantly continuously output the same value.

In the IID test as a test of the random number property, which is performed at the time of manufacturing the physical random number generator, a random number sequence whose random number property is low and which is not detected in the health test is detected.

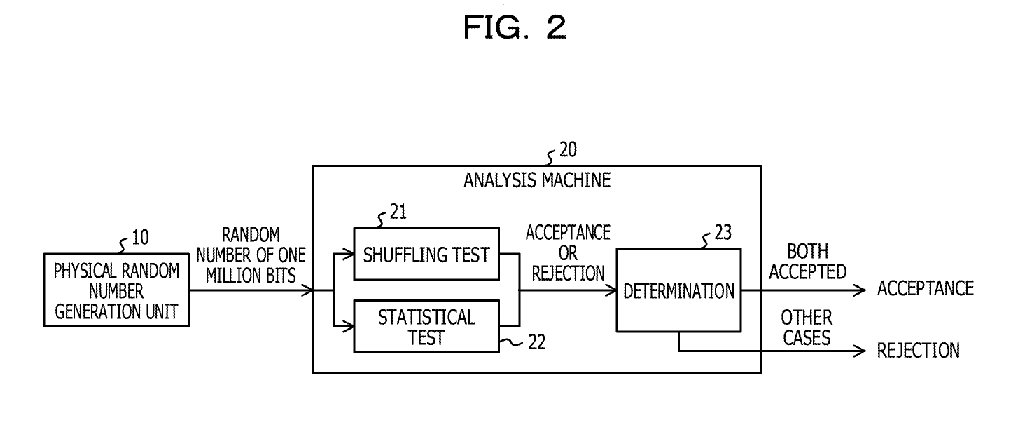

FIG. 2 illustrates an example of a functional block of an analysis machine. The analysis machine illustrated in FIG. 2 performs the IID test. An analysis machine 20 may be realized by a computer device. The analysis machine 20 includes a shuffling test unit 21 that performs the shuffling test, a statistical test unit 22 that performs the statistical test, and a determination unit 23. The analysis machine 20 acquires a random number of one million bits or more from the physical random number generator 10 serving as a test target, subjects the random number to the shuffling test and the statistical test, and determines passing the IID test in a case of passing the two tests.

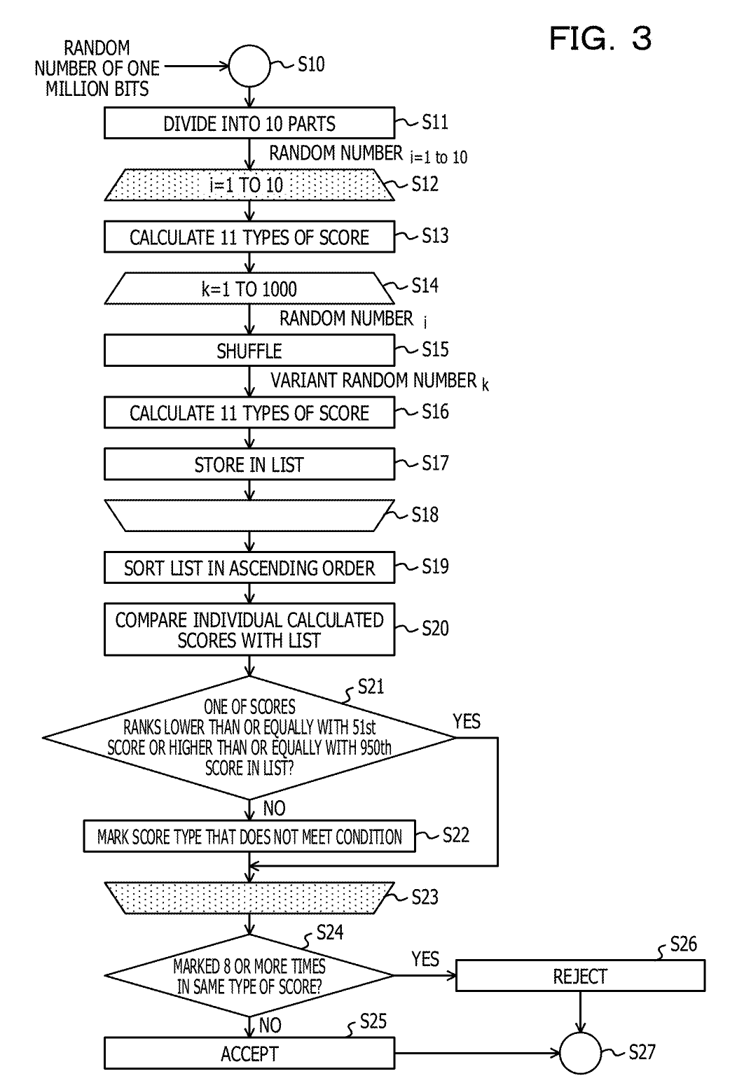

FIG. 3 illustrates an example of processing of a shuffling test. In an operation S10, a random number sequence of one million bits or more, for example, one million bits generated by the physical random number generator 10 is acquired.

In an operation S11, the acquired random number sequence of one million bits or more is divided into 10 equal parts, thereby generating 10 random number sequences of one hundred thousand bits. In an operation S12, a setting for performing processing operations to an operation S23 is performed on each of the random number sequences obtained by being divided into 10 equal parts (the random number sequences of one hundred thousand bits).

In an operation S13, 11 types of score are calculated and stored. The 11 types of score are Compression Score, Over/Under Runs Score×2, Excursion Score, Directional Runs Score×3, Covariance Score, and Collision Score×3, described in [SP800-90B]. In an operation S14, a setting for repeating processing operations to an operation S18 1000 times is performed.

In an operation S15, a random number sequence of one hundred thousand bits is shuffled by a certain procedure, and a variant random number sequence is generated. In an operation S16, the 11 types of score of the shuffled and generated variant random number sequence are calculated.

In an operation S17, the 11 types of score are stored in a score list. In the operation S18, it is determined whether a repetition count reaches 1000, and S14 to S18 are repeated until the repetition count reaches 1000.

The shuffling is performed 1000 times by repeating S14 to S18 1000 times, 1000 variant random number sequences are generated, and 1000 groups of the 11 types of score are calculated and stored in the score list.

In an operation S19, 1000 groups of scores, stored in the score list, are sorted in ascending order with respect to each of the types of score. In an operation S20, individual scores of the random number sequence of one hundred thousand bits before shuffling, calculated in the operation S13, for example, original scores are compared with respective various types of lists tp sorted in ascending order.

In an operation S21, it is determined whether a score out of the 11 types of original score ranks 51st to 949th on a corresponding one of the lists. In addition, in a case of ranking therein, the processing proceeds to the operation S23, and in a case of not ranking therein, the processing proceeds to an operation S22. In the operation S22, an original score, which does not rank 51st to 949th, is marked. If, in the list of, for example, 1000 scores, an original score ranks 51st to 949th, the original score is not marked. In addition, if the original score ranks lower than or equally with the 50th or higher than or equally with the 950th, the original score is marked.

In the operation S23, it is determined whether the repetition count reaches 10, and S12 to S23 are repeated until the repetition count reaches 10. In such a manner as described above, processing of whether or not to mark each of 10 various types of original score is completed.

In an operation S24, for each of the various types, it is determined whether 8 or more out of 10 original scores are marked. If 8 or more original scores are marked, the processing proceeds to an operation S26, and in other cases, for example, in a case where 3 or more original scores are not marked, the processing proceeds to an operation S25.

In the operation S25, the physical random number generator 10 serving as a test target is determined to be accepted, and the processing proceeds to an operation S27 and is terminated. In the operation S26, the physical random number generator 10 serving as a test target is determined to be rejected, and the processing proceeds to the operation S27 and is terminated.

In the statistical test described as the IID test, 2 kinds of chi-square tests are performed. Compared with the shuffling test, the statistical test is a simple test and has a small processing cost.

Since having a large processing cost, the IID test is not implemented at time of using the physical random number generator but, for example, is implemented on the analysis machine or the like only at time of manufacturing the physical random number generator, and a defective physical random number generator whose random number property is low is excluded.

The health test circuit is a circuit for detecting whether or not randomness decreases during using the physical random number generator, and is mounted in a physical random number generator compliant with [SP800-90B]. Since the health test circuit is a simple circuit, a sequence of numbers, not detected by the health test in spite of clearly having no randomness, may exist. For example, 010101010101010101 . . . , 0011001100110011 . . . , 00000000001111111111 . . . , or the like may be undetected. Biased sequences of numbers detected by the health test include, for example, a sequence of numbers in which a same value significantly successively occur, a sequence of numbers in which a 0/1 ratio is significantly biased, and so forth. A sequence of numbers that does not fit into such sequences of numbers may be undetected by the health test.

In this way, a biased sequence of numbers, not detected in the health test, exists.

In the physical random number generator, owing to an environmental change or passage of years, the random number property of an output random number may be reduced. In the IID test performed only at the time of production, no reduction of the random number property at the time of actual use may be detected after shipment. Therefore, a strict test corresponding to the IID test may be performed in an on-chip manner. By mounting, in an on-chip manner, a test circuit capable of performing the strict test, a user of a physical random number generation device may obtain a safe physical random number under various environments, and therefore, the safety of products that utilize information security technologies may be improved.

In the IID test, a biased sequence of numbers, detected by the health test, or a sequence of numbers, not detected by the health test, is detected. Unlike the health test, the IID test is a test performed on the analysis machine at the time of manufacturing the physical random number generator, and a large amount of memory and a large amount of processing time are desired for the test.

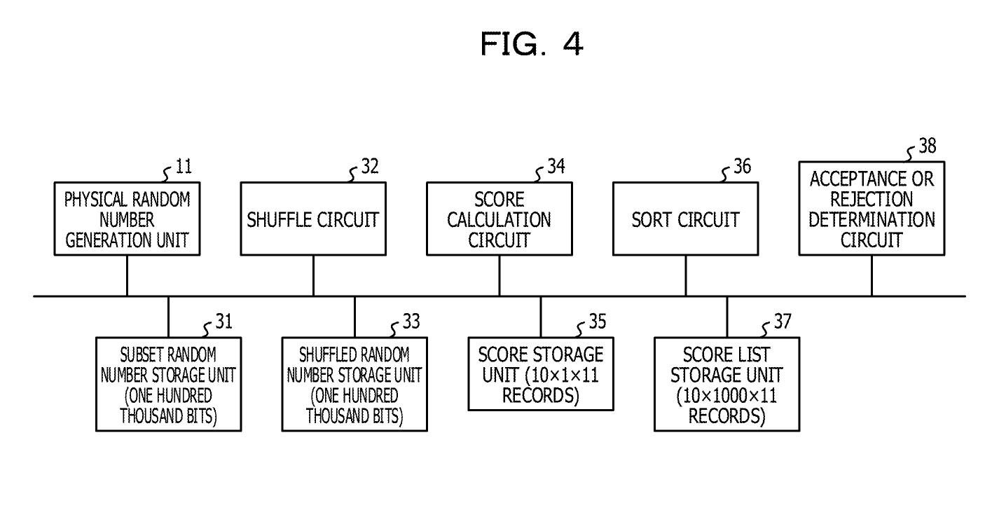

FIG. 4 illustrates an example of a physical random number generator. In FIG. 4, a circuit configuration in a case where a circuit for performing the shuffling test is implemented, in an on-chip manner, in the physical random number generator including the physical random number generation circuit is illustrated. The physical random number generator includes a subset random number storage unit 31, a shuffle circuit 32, a shuffled random number storage unit 33, a score calculation circuit 34, a score storage unit 35, a sort circuit 36, a score list storage unit 37, and an acceptance or rejection determination circuit 38. These may be realized by an on-chip computer system.

In a case where the IID test is performed after a random number sequence of one million bits is acquired, the size of a memory is increased in order to store the random number sequence of one million bits. Therefore, in FIG. 4, the subset random number storage unit 31 has the capacity of one hundred thousand bits, and the operations of from S14 to S22 illustrated in FIG. 3 are performed every time the random number sequence of one hundred thousand bits is accumulated in the subset random number storage unit 31. If the operations of from S14 to S22 finish, a random number sequence of one hundred thousand bits is newly acquired. This processing is repeated 10 times in all. If the random number property of the physical random number generation circuit 11 is good, the 10 random number sequences of one hundred thousand bits generated at intervals may be each considered to have entropy equivalent to that of random number sequences obtained by dividing a continuously generated random number sequence of one million bits into 10 equal parts and may be assumed to be equivalent to the IID test. The capacity of the memory that stores therein the random number sequences generated by the physical random number generation circuit 11 is reduced to 1/10.

The shuffled random number storage unit 33 has the capacity of one hundred thousand bits. In order to store therein the 11 types of score generated 10 times, the score storage unit 35 has the capacity of the 11 types of score (11 records) (448 bits)×10=4,480 bits.

For each of 1000 random number sequences generated by shuffling, the score list storage unit 37 calculates and stores therein the 11 types of score and repeats the processing 10 times. Therefore, the score list storage unit 37 has the capacity of 1000×11 types of score (11 records)×10=4,480,000 bits.

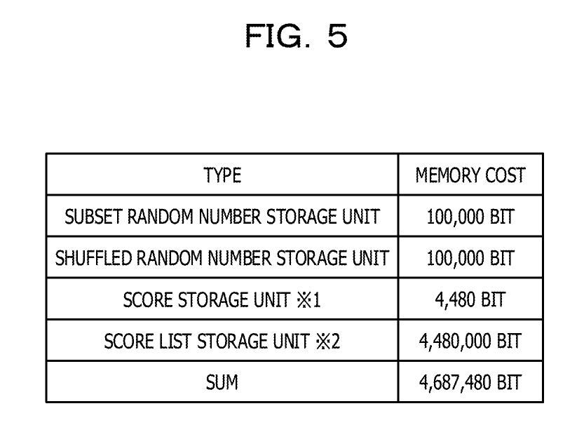

FIG. 5 illustrates an example of a memory cost (capacity). In FIG. 5, a memory cost (capacity) in the circuit configuration implemented in an on-chip manner and illustrated in FIG. 4 is illustrated. As illustrated in FIG. 5, the capacity of 4,687,480 bits is desired and the memory cost may be increased.

Even in a case where the IID test is performed on the analysis machine that utilizes a high-performance computer, a large processing cost (time) (for example, 15 minutes) is taken and processing time in the circuit implemented in an on-chip manner and illustrated in FIG. 4 may be further increased.

Processing costs are, for example, as follows. The sum of shuffle calculation in the operation S15 is 10×1,000 random numbers=10,000. The sum of score calculation in the operations S13 and S16 is 10×1,001 random numbers×11 types of score=110,110.

In a case where the IID test is performed not on the analysis machine but in the circuit in FIG. 4, implemented in an on-chip manner, at the time of using the physical random number generator, a large amount of memory cost and a large amount of processing cost may be taken.

In, for example, the physical random number generator, a test for detecting the occurrence of a random number that has a low random number property and is not detected in the self-test may be performed in a short amount of time and in an on-chip manner.

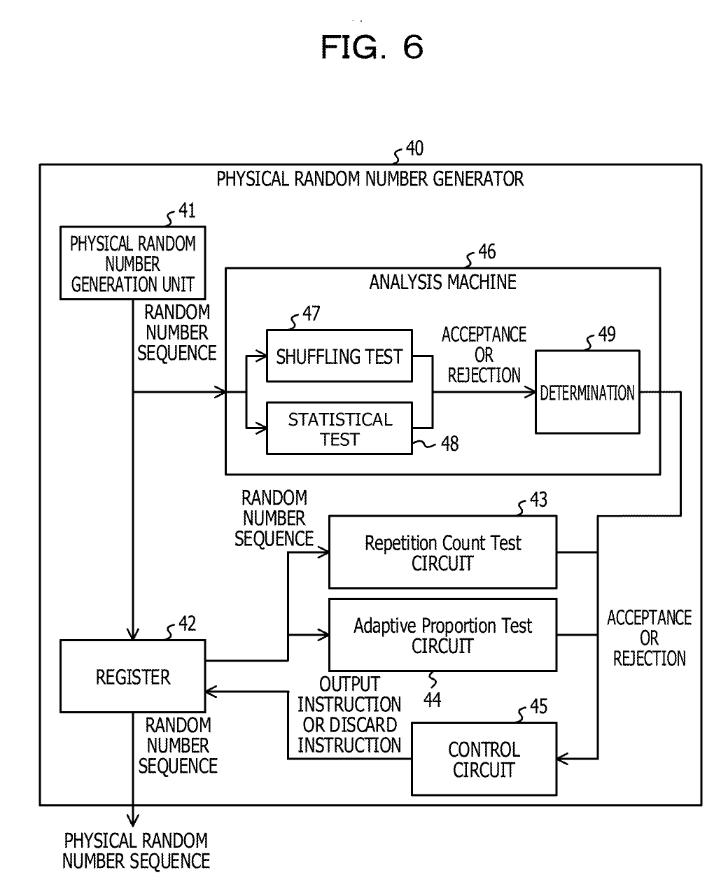

FIG. 6 illustrates an example of a physical random number generator. A physical random number generator 40 illustrated in FIG. 6 includes a physical random number generation circuit 41, a register 42, a Repetition Count Test circuit 43, an Adaptive Proportion Test circuit 44, a control circuit 45, and an analysis test unit 46. The physical random number generation circuit 41, the register 42, the Repetition Count Test circuit 43, the Adaptive Proportion Test circuit 44, and the control circuit 45 may be substantially the same as or similar to respective elements illustrated in FIG. 1, and the descriptions thereof may be omitted or reduced.

The analysis test unit 46 may be realized by an on-chip computer system and may be configured in common with other portions other than the physical random number generation circuit 41. The analysis test unit 46 includes processing function units including a shuffling test unit 47, a statistical test unit 48, and a determination unit 49. The statistical test unit 48 and the determination unit 49 may be substantially the same as or similar to respective elements illustrated in FIG. 2, and the descriptions thereof may be omitted or reduces. While the shuffling test unit 47 may perform a test similar to the shuffling test performed by an element illustrated in FIG. 2, the hardware configuration and the content of processing thereof are different. Compared with the circuit that performs the IID test and that is illustrated in FIG. 4, a memory cost and a processing cost may be small in a test in the shuffling test unit 47.

In the physical random number generator 40 illustrated in FIG. 6, the analysis test unit 46 that performs a test similar to the IID test of [SP800-90B] is incorporated. The analysis test unit 46 tests a physical random number generated by the physical random number generation circuit 41. This test may be performed for every usage. Therefore, problems of the health test may be compensated for. If the same test as the IID test of [SP800-90B] is performed, a memory cost (capacity) and a processing cost (time) increase and on-chip implementation may become difficult. In a case where being performed on, for example, the analysis machine including a high-speed computer, the processing of the shuffling test may take around 15 minutes. Even if the physical random number generator is, for example, a high-performance device equivalent to the analysis machine, waiting for 15 minutes every time acquiring a physical random number is not realistic. Since the computational performance of the physical random number generator mounted in a smartphone or a smart card is inferior as compared with that of the analysis machine, it may take a longer time for the test to finish.

The score list of a variant random number sequence is calculated at the time of manufacturing the physical random number generator, the variant random number sequence being created by shuffling an original random number sequence generated by the physical random number generator, and the score list is written in advance to a nonvolatile memory, for example, the score list storage unit. In a case where the shuffling test is performed in an on-chip manner, score calculation is performed on a newly generated random number sequence, and the calculated scores and the score list stored in advance are compared with each other, thereby performing acceptance or rejection determination. Since the length of the processing time of the shuffling test is attributable to generation of a variant random number by shuffling and the score calculation thereof, the processing time may be reduced by performing those in advance.

In a simple application of the above-mentioned method, the whole of a huge amount of score data of variant random numbers is stored in the nonvolatile memory. Therefore, it may be difficult to mount a large-capacity nonvolatile memory in a physical random number generator or the like for a small-sized embedded device.

In the physical random number generator illustrated in, for example, FIG. 6, the size of the score list storage unit is reduced. It is assumed that “if the random number property of an original random number sequence is high, the random number property of a variant random number sequence generated by randomly shuffling the original random number sequence is high in the same way. Therefore, there is no significant difference between the scores of the original random number sequence and the scores of the variant random number sequence.” Based on the procedure of the shuffling test, this assumption may be confirmed. In a case where a score of a random number whose random number property is high is compared with the score list of a variant random number sequence, a probability of corresponding to a significantly upper rank or a significantly lower rank is low and a probability that it occurs 8 times is the above-mentioned probability to the negative 8th power. In a case where such a phenomenon occurs, the shuffling test determines the random number property of the physical random number generator to be low and rejects the physical random number generator.

The physical random number generator stores, in the score list storage unit, only boundary scores of, for example, the top 5% and the bottom 5% of the score list of the variant random number sequences of the original random number sequence. A circuit for comparing the two values with a score of the original random number sequence is added, and it is determined whether or not the relevant score of the original random number sequence corresponds to the two-sided 5% of the score list of the variant random number sequences. A probability of corresponding to the two-sided 5% 8 or more times out of 10 times is about 10 to the negative 8th power, and if such a state occurs, it is possible to determine that the random number property of the original random number sequence is low. In the physical random number generator, in this way, determination whose level is equivalent to the shuffling test of the IID test may be performed. Since a memory cost and a processing cost taken to perform the statistical test is negligibly small compared with those of the shuffling test, there is no problem in particular in performing the statistical test.

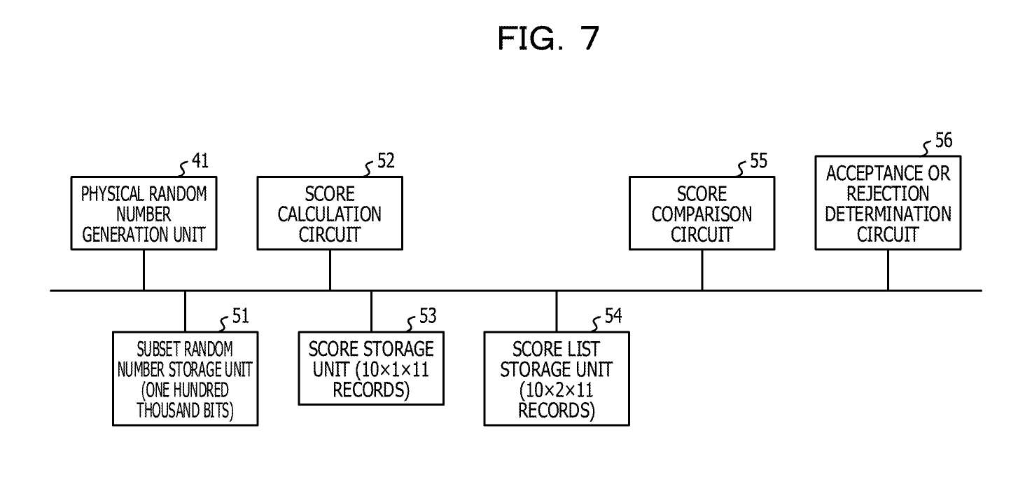

FIG. 7 illustrates an example of a shuffling test unit. In FIG. 7, the functional blocks of the shuffling test unit 47 in the physical random number generator 40 illustrated in FIG. 6 and the physical random number generation circuit 41 are illustrated.

The shuffling test unit 47 in the physical random number generator 40 includes a subset random number storage unit 51, a score calculation circuit 52, a score storage unit 53, a score list storage unit 54, a score comparison circuit 55, and an acceptance or rejection determination circuit 56. These are realized by an on-chip computer system.

As compared with the configuration in FIG. 4, in the shuffling test unit 47 in the physical random number generator 40 illustrated in FIG. 7, the shuffle circuit 32, the shuffled random number storage unit (one hundred thousand bits) 33, and the sort circuit 36 are removed, and the score comparison circuit 55 is added. The size of the score list storage unit 54 may be reduced from 10×1000×11 types of score (11 records) to 10×2×11 types of score (11 records). The size of the score list storage unit may be, for example, 1/500 compared with FIG. 4.

At the time of manufacturing the physical random number generator 40, a manufacturer performs, on the physical random number generator 40, the IID test of [SP800-90B] including the shuffling test illustrated in FIG. 3. If a result of the IID test is rejection, the physical random number generator 40 is discarded and not shipped. If the result of the IID test is acceptance, the 51st score and the 949th score from the top on the sorted score list of the variant random number sequences, obtained in the operation S19 in FIG. 3, are acquired with respect to each of the types of score and written to the score list storage unit 54 in the physical random number generator 40. Since the score list is generated for 10 random number sequences of one hundred thousand bits, 10 groups of score groups are generated. Hereinafter, the 51st score group from the top is called an upper boundary score, and the 949th score group is called a lower boundary score.

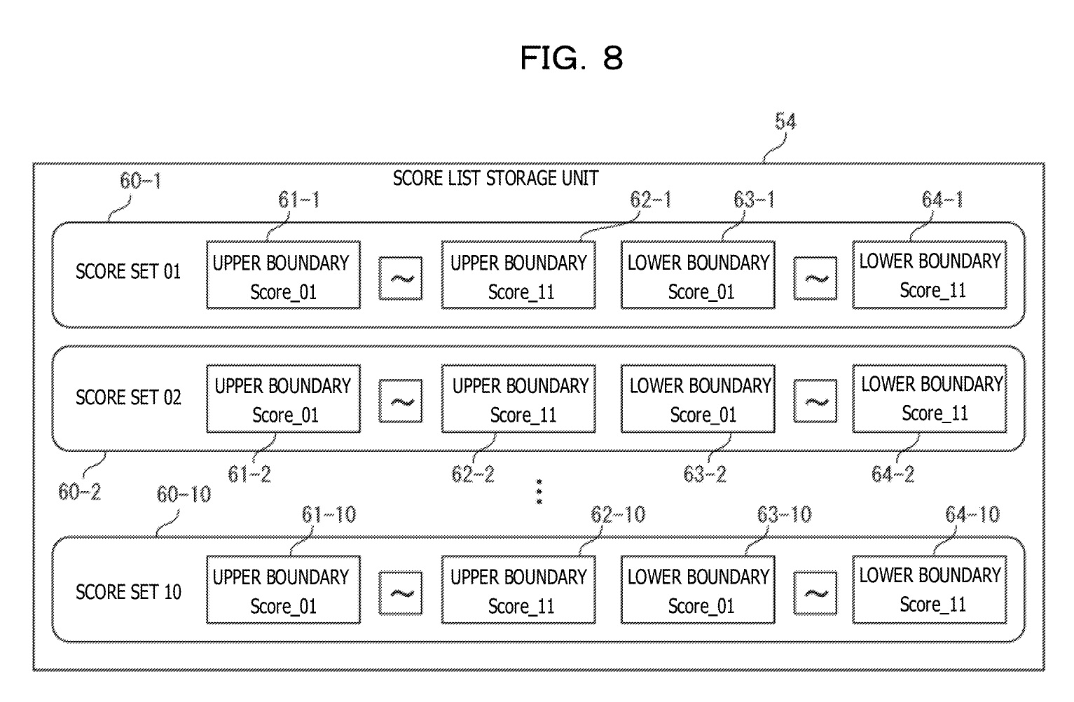

FIG. 8 illustrates an example of a score list storage unit. In FIG. 8, 10 groups of the 11 types of score group are stored in the score list storage unit 54. A score group 60-1 stores therein a score set 01 and stores therein upper boundary scores 61-1 and 62-1 and lower boundary scores 63-1 and 64-1 of score groups Score_01 to Score_11 of 11 types in the score set 01. For example, 11 types of upper boundary score and 11 types of lower boundary score are stored. Other score groups 60-2 to 60-10 are stored in the similar way.

The data length of a score varies depending on the type thereof, and the sum of data lengths of the 11 types of score is 448 bits. Since one score set has 11 types of score for each of an upper rank and a lower rank, the sum of data lengths is 448×2=896 bits. Since the score list storage unit 54 holds 10 score sets, the sum of data lengths is 896×10=8,960 bits.

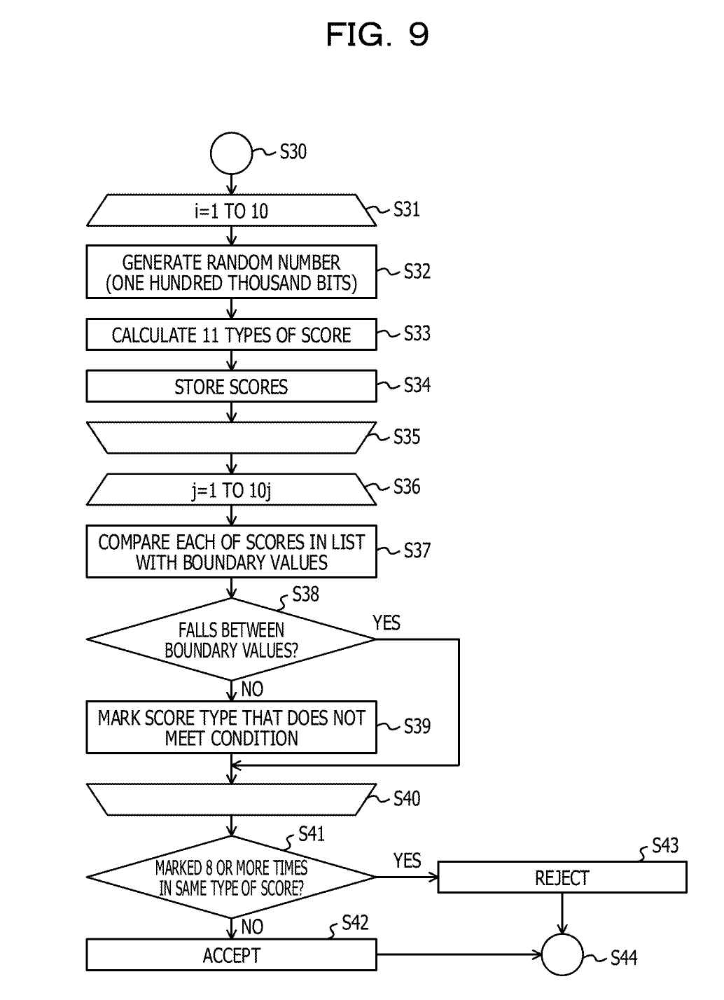

FIG. 9 illustrates an example of physical random number generation processing. FIG. 9 illustrates a procedure performed by the physical random number generator 40 illustrated in FIG. 6 when a user requests to generate a physical random number after shipment.

In an operation S30, processing is started. In an operation S31, an initial setting for repeating processing operations to an operation S35 10 times is performed. In an operation S32, the physical random number generation circuit 41 generates a random number sequence of one hundred thousand bits, and the random number sequence is stored in the register 42.

In an operation S33, the score calculation circuit 52 calculates 11 types of score for the obtained random number sequence of one hundred thousand bits. In an operation S34, the score calculation circuit 52 stores the calculated scores in the score storage unit 53.

In an operation S35, it is determined whether a repetition count reaches 10, and S31 to S35 are repeated until the repetition count reaches 10. Based on the above-mentioned processing, 10 sets of the 11 types of score are stored in the score storage unit 53.

In an operation S36, an initial setting for repeating processing operations to an operation S40 10 times is performed. In an operation S37, the score comparison circuit 55 takes, from the score list storage unit 54, one set of upper boundary scores (11 types) and lower boundary scores (11 types) and takes one set of 11 types of score stored in the score storage unit 53, thereby performing comparison.

In an operation S38, in a case where various types of score of the one set taken from the score storage unit 53 fall between the respective upper boundary scores and the respective lower boundary scores, the processing proceeds to an operation S40, and in other cases, the processing proceeds to an operation S39. In the operation S39, the score comparison circuit 55 marks a score that does not fall between a corresponding one of the upper boundary scores and a corresponding one of the lower boundary scores. In the operation S40, it is determined whether a repetition count reaches 10, and S36 to S40 are repeated until the repetition count reaches 10.

In an operation S41, the acceptance or rejection determination circuit 56 determines whether the same type of score is marked 8 or more times. In addition, in a case where the same type of score is marked 8 or more times, the processing proceeds to an operation S43, and in a case where the same type of score is marked 7 or less times, in other words, no mark is assigned to the same type of score 3 or more times, the processing proceeds to an operation S42. In the operation S42, the acceptance or rejection determination circuit 56 determines acceptance, and the processing proceeds to an operation S44 and is terminated. In the operation S43, the acceptance or rejection determination circuit 56 determines rejection, and the processing proceeds to the operation S44 and is terminated.

Based on the above-mentioned processing, it is determined whether or not passing the shuffling test. In addition, in a case of passing, the statistical test is further performed, and in a case of passing the statistical test, the physical random number generator 40 illustrated in FIG. 6 is determined to normally function. In a case of failing the shuffling test or failing the statistical test while passing the shuffling test, the physical random number generator 40 illustrated in FIG. 6 is determined to abnormally function, and a user is informed to that effect. The statistical test does not have to be performed.

The shuffling test is reduced to 1/1000, compared with the processing illustrated in FIG. 3.

If the physical random number generator 40 illustrated in FIG. 6 is determined to normally function, the physical random number generation circuit 41 generates a random number, and the random number is stored in the register 42. The health test is performed on that random number. In addition, in a case of rejection, the random number is discarded, and in a case of acceptance, the random number is output.

A random number sequence of, for example, one hundred thousand bits is generated 10 times, 11 types of score are calculated for each of the 10 generated random number sequences, and it is determined whether or not to mark. After that, in a case where the same type of score is marked 8 times out of 10 times, rejection is determined. In a case where the same type of score is not marked 3 times out of 10 times, further calculation does not have to be performed on that score. In a case where, for example, a procedure to be performed when a user requests to generate a physical random number is changed and normality is proved, the shuffling test may be terminated.

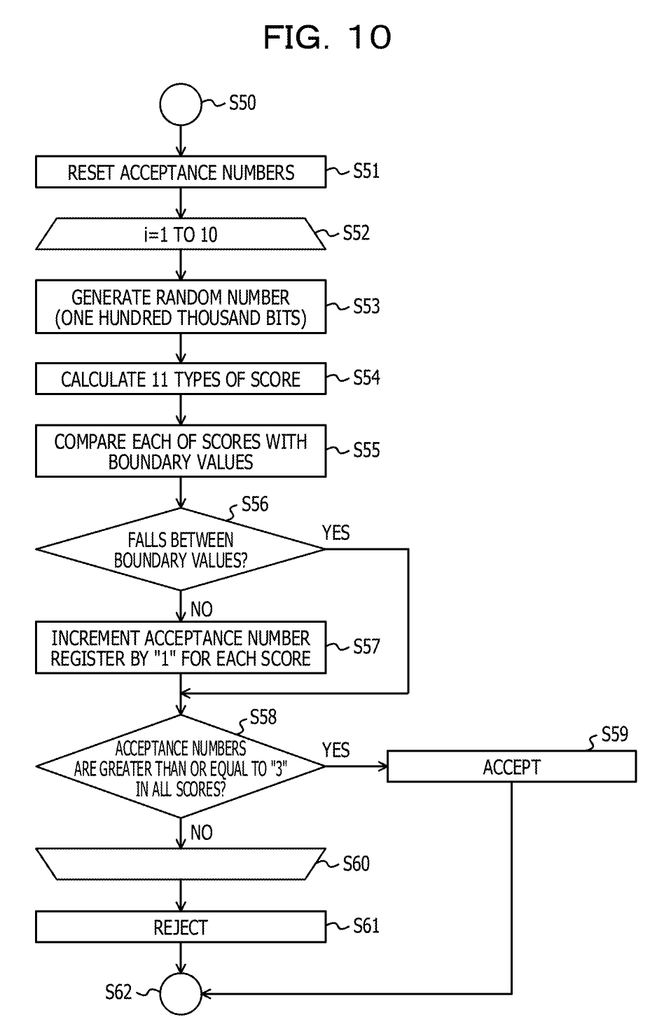

FIG. 10 illustrates an example of a physical random number generation processing. A physical random number generator that performs the processing illustrated in FIG. 10 may have substantially the same configuration as or a configuration similar to that of physical random number generator 40 illustrated in FIG. 6. The physical random number generator is different in that an acceptance number register is provided and the physical random number generation processing is performed when a user requests to generate a physical random number. In FIG. 10, a procedure to be performed after shipment when the physical random number generator 40 is requested by a user to generate a physical random number is described.

In an operation S50, processing is started. In an operation S51, an acceptance number register for each of scores is reset to zero. In an operation S52, an initial setting for repeating processing operations to an operation S60 10 times is performed. In an operation S53, the physical random number generation circuit 41 generates a random number sequence of one hundred thousand bits, and the random number sequence is stored in the register 42.

In an operation S54, the score calculation circuit 52 calculates 11 types of score for the obtained random number sequence of one hundred thousand bits. In an operation S55, the score comparison circuit 55 takes, from the score list storage unit 54, one set of upper boundary scores (11 types) and lower boundary scores (11 types) and compares the calculated 11 types of score with the respective upper boundary scores and the respective lower boundary scores.

In an operation S56, in a case where the calculated various types of score falls between the respective upper boundary scores and the respective lower boundary scores, the processing proceeds to an operation S58, and in other cases, the processing proceeds to an operation S57. In the operation S57, with respect to each of the calculated scores, in a case where the relevant calculated score does not fall between a corresponding one of the upper boundary scores and a corresponding one of the lower boundary scores, the score comparison circuit 55 increments a corresponding one of the acceptance number registers by “1”.

In the operation S58, it is determined whether the values of the acceptance number registers are greater than or equal to “3” in all the calculated scores. In addition, in a case of being less than “3”, the processing proceeds to the operation S60, and in a case of being greater than or equal to “3”, the processing proceeds to an operation S59 and breaks out of a loop of S52 to S60. In the operation S59, the acceptance or rejection determination circuit 56 determines acceptance, and the processing proceeds to an operation S62 and is terminated.

In the operation S60, it is determined whether a repetition count reaches 10, and S52 to S60 are repeated until the repetition count reaches 10. In an operation S61, the acceptance or rejection determination circuit 56 determines rejection, and the processing proceeds to the operation S62 and is terminated.

Processing subsequent to this may be substantially the same as or similar to the processing illustrated in FIG. 9. In a case where every score has acceptance, for example, 3 or more times, normally functioning becomes evident. Therefore, the shuffling test may be terminated. Therefore, a test speed may be improved.

For example, the scores stored in the score list storage unit 54 are not limited to the 51st one and the 949th one. For example, a boundary value and a range specified by the boundary value may be arbitrarily set.

Compared with the health test, the above-mentioned physical random number generator detects a biased random number sequence with a higher degree of accuracy. While, in the health test, in view of an algorithm, it is difficult to detect a sequence of numbers in which a fixed pattern such as “01010101” is repeated, the above-mentioned physical random number generator detects such a sequence of numbers. The above-mentioned physical random number generator may comply with, for example, the IID test of [SP800-90B] and detects the significant bias of the 0/1 ratio or the significant succession of the same value. An advance test of whether each of elements of a random number sequence independently emerges may be implemented.

In the physical random number generation processing illustrated in FIG. 9 or FIG. 10, a biased random number sequence (examples: a repeat of the same pattern, the significant bias of the 0/1 ratio (low entropy), existence of a correlative relationship between individual elements, and so forth) is detected. Therefore, a safe physical random number may be provided to a user of the physical random number generator. Using the safe physical random number as a seed, a safe secret key is generated. Therefore, the safety of products that utilize information security technologies such as encryption may be improved.

Owing to an environmental change or passage of years, the random number property of a random number output by the physical random number generator may be reduced. In a case where, as described in, for example, [SP800-90B], a strict test as the IID test is performed only at the time of production, no reduction of the random number property at the time of actual use may be detected after shipment. In order to reduce such a state, a strict test may be performed in an on-chip manner. In the above-mentioned physical random number generator, the strict test is performed in an on-chip manner. Therefore, a user of the physical random number generator may obtain a safe physical random number under various environments, and the safety of products that utilize information security technologies may be improved.

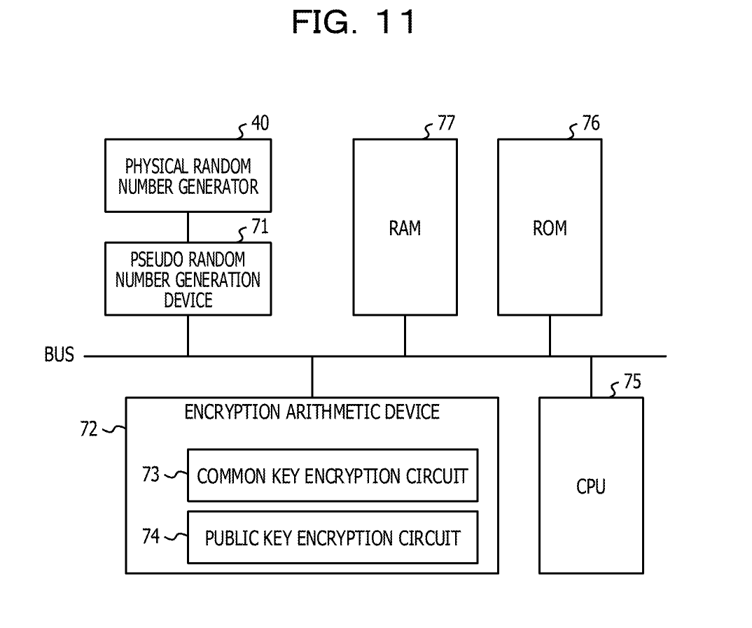

FIG. 11 illustrates an example of an electronic device. In FIG. 11, an electronic device that has an encryption arithmetic function utilizing the above-mentioned physical random number generator is illustrated.

The electronic device includes a physical random number generator 40, a pseudo random number generation device 71, an encryption arithmetic device 72, a CPU 75, a ROM 76, and a RAM 77. The encryption arithmetic device 72 includes a common key encryption circuit 73, and a public key encryption circuit 74. The physical random number generator 40 may be the above-mentioned physical random number generator. The pseudo random number generation device 71 generates a pseudo random number sequence by using, as a seed, a physical random number generated by the physical random number generator 40.

The encryption arithmetic device 72 generates a secret key by using the pseudo random number generation device 71 and provides, to a user, an encryption function based on the safe secret key. In the encryption arithmetic device 72, a common key is generated by the common key encryption circuit 73 and encryption processing related to the common key is performed. In addition, a public key is generated by the public key encryption circuit 74 and encryption processing related to the public key is performed. The pseudo random number generation device 71 and the encryption arithmetic device 72 may be realized by a known technology.

The CPU 75, the ROM 76, and the RAM 77 form a computer and perform processing of the electronic device. The electronic device including the physical random number generator may be a product including an encryption function. In such an electronic device, the computer performs processing in which encryption generated by the encryption arithmetic device 72 is used, for example, processing corresponding to an authentication result of authentication processing. As the product including the encryption function, a mobile phone, a smart card, a computer, a printer, or the like is cited. A game machine or the like uses a generated physical random number, and in an electronic device such as the game machine, the above-mentioned physical random number generator may be effectively used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A quality detecting method, comprising:
storing, in a memory, an upper limit value and a lower limit value that specify a distribution range of a score corresponding to at least one type for each of variant random number sequences generated by shuffling an initial random number sequence; and
causing a computer to:
generate verification random number sequences;
calculate a score corresponding to the type for each of the verification random number sequences;
compare the scores of the verification random number sequences with the upper limit value and the lower limit value;
acquire a frequency at which the scores of the verification random number sequences are distributed in the distribution range based on a comparison result; and
detect, based on the frequency, quality of a physical random number generation circuit.

2. The quality detecting method according to claim 1, wherein the computer:
determines, for each calculation of the score for each of the verification random number sequences, whether or not each of the scores is distributed in the distribution range; and
stops generation of the verification random number sequences at a time when detection is completed based on two or more detecting results.

3. The quality detecting method according to claim 1, wherein
the initial random number sequence is a random number sequence of one million bits or more, and
values of a number of sets that specify distribution ranges of the type of score of random number sequences obtained by dividing the initial random number sequence into the number of equal parts are stored in the memory.

4. The quality detecting method according to claim 1, wherein
the type includes a plurality of types, and
the score is calculated for each of the plurality of types.

5. The quality detecting method according to claim 1, wherein
boundary values of top N % and bottom N % (N is a positive integer) of the distribution range are stored as the upper limit value and the lower limit value, respectively.

6. The quality detecting method according to claim 1, wherein the computer determines to be defective in a case where scores of a given number out of the scores for the verification random number sequences are greater than the upper limit value or are less than the lower limit value.

7. The quality detecting method according to claim 1, wherein
the storing of the upper limit value and the lower limit value are performed at the time of manufacturing the physical random number generator, and
the generating the verification random number sequences and the detecting the quality are performed at the time of use of the physical random number generator after shipment.

8. A random number generator comprising:
a physical random number generation circuit;
a first memory configured to store an upper limit value and a lower limit value that specify a distribution range of a score corresponding to at least one type for each of variant random number sequences generated by shuffling an initial random number sequence generated by the physical random number generation circuit; and
a processor configured to perform processing by using the upper limit value and the lower limit value stored in the first memory, wherein
the processor:
calculates scores corresponding to the type for verification random number sequences generated by the physical random number generation circuit;
compares the scores with the upper limit value and the lower limit value stored in the first memory;
acquires, based on a comparison result, a frequency at which the scores of the verification random number sequences are distributed in the distribution range; and
detects, based on the frequency, quality of the physical random number generation circuit.

9. The random number generator according to claim 8, further comprising:
a second memory configured to store the verification random number sequences, wherein
the verification random number sequences are output from the second memory based on a detecting result.

10. The random number generator according to claim 8, wherein
a comparison is performed for each calculation of the scores, and
generation of the verification random number sequences is stopped at a time after two or more detection.

11. The random number generator according to claim 8, wherein
storing of the upper limit value and the lower limit value in the first memory is performed at the time of manufacturing the physical random number generator.

12. An electronic device comprising:
a random number generator; and
an arithmetic device configured to perform processing by using a random number generated by the random number generator, wherein
the random number generator includes:
a physical random number generation circuit;
a first memory configured to store an upper limit value and a lower limit value that specify a distribution range of a score corresponding to at least one type for each of variant random number sequences generated by shuffling an initial random number sequence generated by the physical random number generation circuit; and
a processor configured to perform processing by using the upper limit value and the lower limit value stored in the first memory, wherein
the processor:
calculates scores corresponding to the type for verification random number sequences generated by the physical random number generation circuit;
compares the scores with the upper limit value and the lower limit value, stored in the first memory;
acquires, based on a comparison result, a frequency at which the scores of the verification random number sequences are distributed in the distribution range; and
detects, based on the frequency, quality of the physical random number generation circuit.

13. The electronic device according to claim 12, further comprising:
a second memory configured to store the verification random number sequences, wherein
the verification random number sequences are output from the second memory, based on a detecting result.

14. The electronic device according to claim 12, wherein
a comparison is performed for each calculation of the scores, and
a generation of the verification random number sequences is stopped after two or more detection.

15. The electronic device according to claim 12, wherein
storing of the upper limit value and the lower limit value in the first memory is performed at the time of manufacturing the physical random number generator.
